(19) United States
(12) Patent Application Publication
(10) Pub. No.: US 2011/0146515 A1
(43) Pub. Date: Jun. 23, 2011

(54) PRINTING PLATE FOR GRAVURE PRINTING, METHOD OF MANUFACTURING THE SAME, AND METHOD OF FORMING PRINTING PATTERN USING THE PRINTING PLATE

(75) Inventors: Youn-Gu Lee, Suwon-si (KR); Seung-Jun Lee, Yongin-si (KR); Kyu-Young Kim, Suwon-si (KR); Nam-Ok Jung, Hwaseong-si (KR); Jae-Hyuk Chang, Seongnam-si (KR)

(73) Assignee: SAMSUNG ELECTRONICS CO., LTD., Suwon-si (KR)

(21) Appl. No.: 12/788,659

(22) Filed: May 27, 2010

(30) Foreign Application Priority Data
Dec. 22, 2009 (KR) 2009-0128585

(51) Int. Cl. B41N 1/00; C23F 1/00

(52) U.S. Cl. 101/395; 216/37

(57) ABSTRACT

A printing plate for gravure printing includes; a base body, a first convex portion disposed having a first height on the base body, a concave portion disposed between adjacent regions of the first convex portion, and a second convex portion disposed in the concave portion and having a second height smaller than that of the first height, wherein the concave portion includes a first concave portion and a second concave portion and a width of the second concave portion is larger than that of the first concave portion, and the second convex portion is disposed within the second concave portion.

This application claims priority to Korean Patent Application No. 2009-128585, filed on Dec. 22, 2009, and all the benefits accruing therefrom under 35 U.S.C. §119, the content of which in its entirety is herein incorporated by reference.

### BACKGROUND OF THE INVENTION

1. Field of the Invention

Exemplary embodiments of the present invention relate to a printing plate for gravure printing, a method of manufacturing the printing plate and a method of forming a printing pattern using the printing plate. More particularly, exemplary embodiments of the present invention relate to a printing plate for gravure printing capable of forming a large-sized printing pattern, a method of manufacturing the printing plate and a method of forming a printing pattern using the printing plate.

2. Description of the Related Art

Generally, a liquid crystal display (“LCD”) apparatus has a relatively slim thickness, light weight and low power consumption in comparison to other display types, and thus the LCD apparatus is often used as a display device in various applications such as a computer monitor, a laptop, a cellular phone and other applications.

Generally, the typical LCD apparatus includes an LCD panel displaying an image using light transmittance characteristics of liquid crystal molecules, and a backlight assembly disposed under the LCD panel which provides light to the LCD panel.

The typical LCD panel includes a signal line, an array substrate including a thin-film transistor (“TFT”) and a pixel electrode, an opposite substrate facing the array substrate and including a color filter and a common electrode, and a liquid crystal layer disposed between the array substrate and the opposite substrate.

The signal line, the TFT, the pixel electrode, the color filter and a column spacer are typically formed by a patterning process. A conventional patterning process is usually performed via an exposure process including cleaning, photoresist coating and developing processes, etc. Thus, manufacturing costs of the typical LCD apparatus increase due to the use of expensive exposure equipment, a manufacturing process is also complicated and manufacturing time is relatively long due to the use of the various kinds of processes described above.

To solve the above-mentioned problem, a printing method has been developed. As an example of the printing method, a gravure-offset printing method has been introduced in order to reduce the complication and expense of the manufacturing process.

In the gravure offset printing method, a concave portion of a printing plate is filled with an ink and then ink disposed in non-recessed portions of the printing plate is removed using a doctor blade which functions as a squeegee, and the ink inside of the printing plate is offset to a roll-type blanket by rolling the roll-type blanket on the printing plate, and then the ink is transferred on a glass substrate by rolling the roll-type blanket on the glass substrate.

Accordingly, the exposure and developing processes for the patterning process are unnecessary in the gravure offset printing method, so the manufacturing costs may be decreased and the manufacturing process may be simplified and the gravure offset printing method may realize a mass production benefit.

However, if a length of a portion on which the doctor blade makes continuous contact with the concave portion increases, i.e. if a width of the concave portion is relatively large, the doctor blade is bent into the concave portion so that the doctor blade may undesirably partially remove the ink inside of the concave portion. Accordingly, if the offset process is performed without entirely filling the concave portion with the ink, only a small quantity of the ink, i.e., less than that intended, is offset to the blanket. Thus, the desired pattern may not be completely formed.

### BRIEF SUMMARY OF THE INVENTION

Exemplary embodiments of the present invention provide a printing plate for gravure printing forming a large-sized printing pattern.

Exemplary embodiments of the present invention provide a method of manufacturing the printing plate.

Exemplary embodiments of the present invention provide a method of forming a printing pattern using the printing plate.

According to an exemplary embodiment of the present invention, a printing plate for gravure printing includes; a base body, a first convex portion disposed having a first height on the base body, a concave portion disposed between adjacent regions of the first convex portion, and a second convex portion disposed in the concave portion and having a second height smaller than the first height, wherein the concave portion includes a first concave portion and a second concave portion, and a width of the second concave portion is larger than that of the first concave portion, and the second convex portion is disposed within the second concave portion.

In one exemplary embodiment, the base body may include glass.

In one exemplary embodiment, the first and second convex portions may be integrated with the base body into a single, unitary and indivisible body.

In one exemplary embodiment, the width of the first concave portion may be about 100 μm or more.

In one exemplary embodiment, the second convex portion may be formed as an island shape.

In one exemplary embodiment, the second convex portion may have one of a quadrangular shape, a circular shape and an elliptical shape when viewed from a top plan view.

In one exemplary embodiment, the second convex portion may be plural in number.

In one exemplary embodiment, the second convex portion has a bar shape which extends from both sides of the second concave portion when viewed from a top plan view.

According to another exemplary embodiment of the present invention, a method of manufacturing a printing plate for gravure printing includes; disposing a metal layer on a base substrate, disposing a photo pattern on the base substrate on which the metal layer is disposed, forming a metal pattern using the photo pattern as a mask and etching the base substrate using the metal pattern as a mask to form a first concave portion defined as a space between adjacent first convex portions having a first height as measured from the base substrate and to form a second concave portion having a width larger than that of the first concave portion and including a second convex portion inside of the second concave portion, wherein the second convex portion has a second height smaller than the first height as measured from the base substrate.

In one exemplary embodiment, the method may further include a step of removing the metal pattern and the photo pattern after the first and second concave portions are formed.

In one exemplary embodiment, the photo pattern disposed in an area where the second convex portion is formed may have a width about twice as large as a depth of the first and second concave portions.

In one exemplary embodiment, the photo pattern and the metal pattern disposed in an area where the second convex portion is formed may be removed via etching the base substrate to form the first and second concave portions.

In one exemplary embodiment, the base substrate may be isotropically etched.

According to still another exemplary embodiment of the present invention, there is provided a method of forming a printing pattern using a printing plate for gravure printing, the method including; forming a printing plate including a base body, a first convex portion disposed on the base body with a first height, a concave pattern disposed between adjacent regions of the first convex portion and a second convex portion disposed in the concave pattern and having a second height, wherein the concave pattern includes a first concave portion having a first width and a second concave portion having a second width larger than the first width and the second convex portion is disposed within the second concave portion, filling the concave pattern on the printing plate with an ink, rolling a blanket on the printing plate filled with the ink to offset the ink to the blanket and transferring the ink to a substrate by rolling the blanket to which the ink is offset on the substrate.

In one exemplary embodiment, the second convex portion may prevent a doctor blade from entering into the second concave portion when the printing plate is coated with the ink, and the ink may be shaved with the doctor blade to fill the first and second concave portions with the ink.

In one exemplary embodiment, the printing plate may be formed by disposing a metal layer on a base substrate, disposing a photo pattern on the base substrate on which the metal layer is disposed, forming a metal pattern using the photo pattern as a mask, and etching the base substrate using the metal pattern as a mask to form the first concave portion and the second concave portion, the second concave portion including the second convex portion disposed therein.

According to the present invention, the doctor blade may prevent the ink inside of the concave portion of the printing plate from being removed, and thus a large-sized printing pattern may be manufactured via the gravure printing process.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a top plan view illustrating an exemplary embodiment of a printing plate for gravure printing according to the present invention;

FIG. 2 is a cross-sectional view taken along line I-I′ of FIG. 1;

FIGS. 3A to 3F are cross-sectional views explaining an exemplary embodiment of a method of manufacturing the printing plate illustrated in FIG. 1;

FIGS. 4A to 4D are cross-sectional views explaining an exemplary embodiment of a method of forming a printing pattern using the exemplary embodiment of a printing plate of FIG. 1;

FIG. 5 is a top plan view illustrating another exemplary embodiment of a printing plate for gravure printing according to the present invention;

FIG. 6 is a top plan view illustrating another exemplary embodiment of a printing plate for gravure printing according to the present invention;

FIG. 7 is a top plan view illustrating another exemplary embodiment of a printing plate for gravure printing according to the present invention; and

FIG. 8 is a top plan view illustrating another exemplary embodiment of a printing plate for gravure printing according to the present invention.

### DETAILED DESCRIPTION OF THE INVENTION

The present invention is described more fully hereinafter with reference to the accompanying drawings, in which example embodiments of the present invention are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity. Like reference numerals refer to like elements throughout.

It will be understood that when an element or layer is referred to as being “on” another element, it can be directly on the other element or intervening elements may be present. In contrast, when an element is referred to as being “directly on,” “another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the apparatus in use or operation in addition to the orientation depicted in the figures. For example, if the apparatus in the figures is turned over, elements described as “below” or “beneath” other elements or features would then be oriented “above” the other elements or features. Thus, the exemplary term “below” can encompass both an orientation of above and below. The apparatus may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments of the invention are described herein with reference to cross-sectional illustrations that are schematic illustrations of idealized example embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of an apparatus and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be explained in detail with reference to the accompanying drawings.

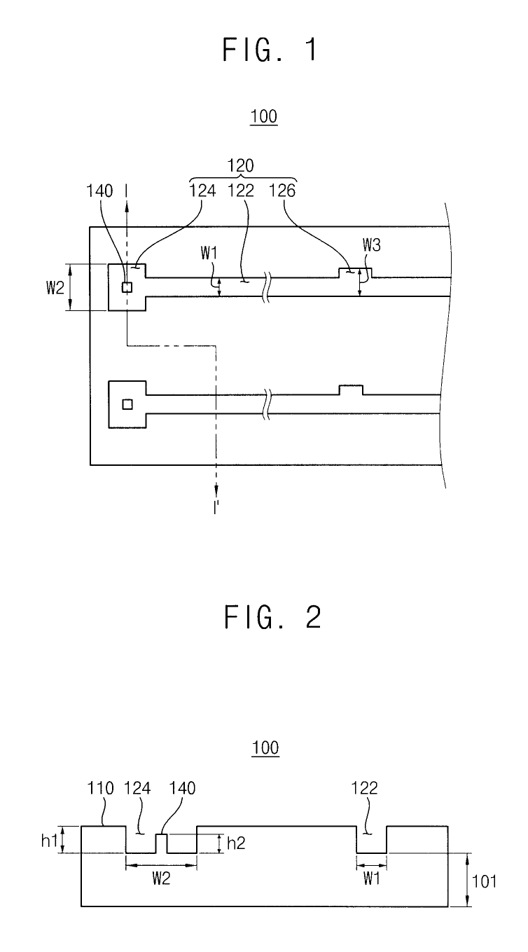

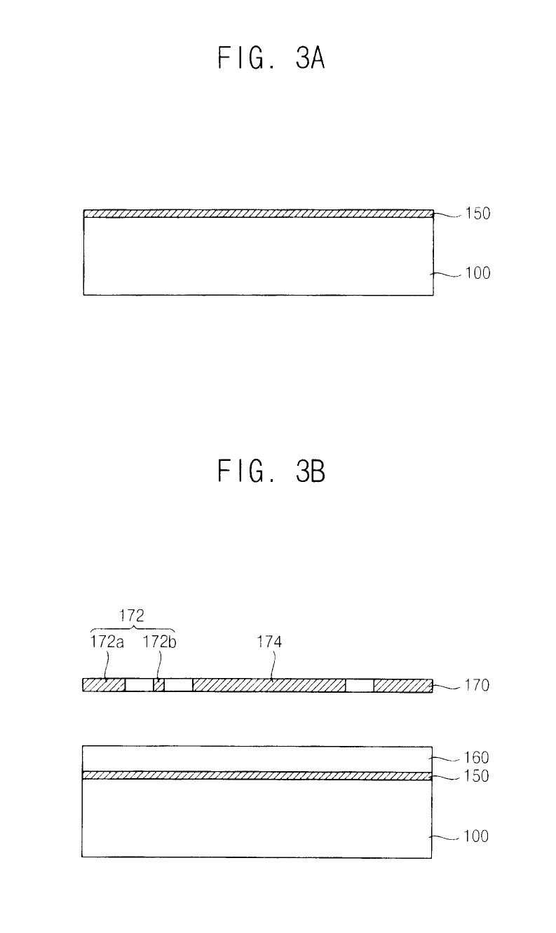

FIG. 1 is a top plan view illustrating an exemplary embodiment of a printing plate for gravure printing according to the present invention. FIG. 2 is a cross-sectional view taken along line I-I′ of FIG. 1.

In the present exemplary embodiment, a printing plate for forming a gate metal layer formed on a display substrate is explained. The gate metal layer includes a gate line, a gate pad connected to an end of the gate line wherein the gate pad transfers a gate signal to the gate line during operation, and a gate electrode of a thin-film transistor (“TFT”) extending from the gate line.

Referring to FIGS. 1 and 2, the present exemplary embodiment of a printing plate 100 for gravure printing includes a base body 101, a first convex portion 110 and a concave portion 120.

In one exemplary embodiment, the base body 101 may include glass.

The first convex portion 110 is formed on the base body 101 and has a first height h1 measured from the top surface of the base body 101.

The concave portion 120 is defined by adjacent first convex portions 110 and includes a first concave portion 122, a second concave portion 124 and a third concave portion 126 corresponding to the eventual formation of the gate line, the gate pad and the gate electrode, respectively, as will be described in more detail below.

The first, second and third concave portions 122, 124 and 126 are defined as areas between adjacent first convex portions 110. The first concave portion 122 has a first width W1, the second concave portion 124 has a second width W2, and the third concave portion 126 has a third width W3. The second width W2 may be larger than the first width W1. The third width W3 may be larger than the first width W1 and smaller than the second width W2. For example, in one exemplary embodiment the second width W2 may be no less than about 100 μm.

The first concave portion 122 may correspond to the gate line, the second concave portion 124 may correspond to the gate pad, and the third concave portion 126 may correspond to the gate electrode, as discussed above.

The second concave portion 124 includes a second convex portion 140.

The second convex portion 140 is disposed inside of the second concave portion 124, and may have a second height h2 smaller than a first height h1 of the first convex portion 110 as measured from the base body 101. As illustrated in FIGS. 1 and 2, the second convex portion 140 may be formed as an island shape. In addition, as illustrated in FIGS. 1 and 2, the second convex portion 140 may be formed as a quadrangular shape.

The second convex portion 140 prevents a doctor blade (not illustrated) which is used to fill the first, second and third concave portions 122, 124, 126 with ink (not illustrated) from entering inside of the second concave portion 124. In one exemplary embodiment, the first convex portion 110 and the second convex portion 140 may be integrated with the base body 101 into a single body.

When the second height h2 of the second convex portion 140 is equal to the first height h1 of the first convex portion 110, the ink inside of the second concave portion 124 is separated by the second convex portion 140, e.g., the second convex portion 140 extends beyond the ink and thus forms an island, so that a desired size of a pattern may not be formed. Thus, in the present exemplary embodiment, the second height h2 of the second convex portion 140 is smaller than the first height h1 of the first convex portion 110.

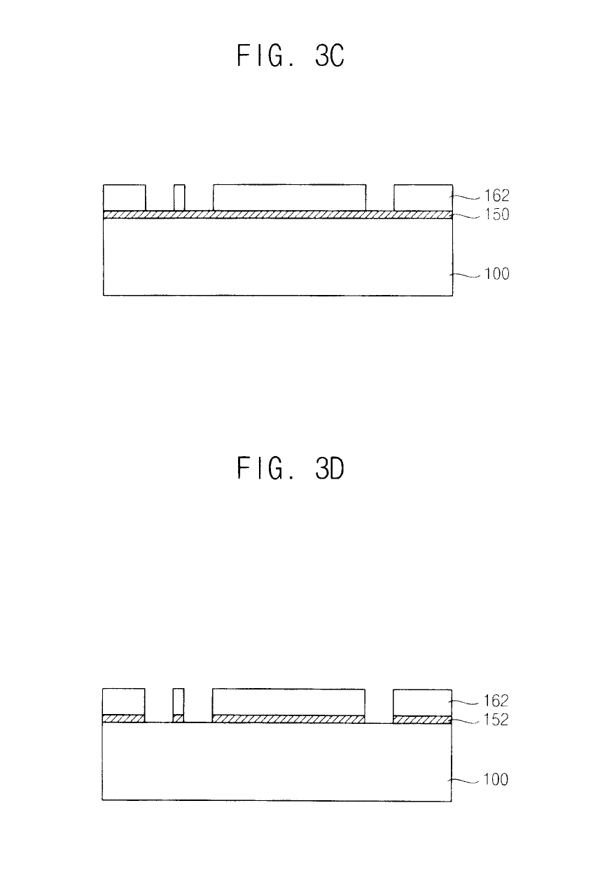

FIGS. 3A to 3F are cross-sectional views explaining an exemplary embodiment of a method of manufacturing the exemplary embodiment of a printing plate illustrated in FIG. 1.

At first, as illustrated in FIG. 3A, a metal layer 150 is formed on a printing plate 100. For example, exemplary embodiments of the printing plate 100 may include glass or other materials with similar characteristics such as quartz. The metal layer 150 may include one of aluminum (Al), copper (Cu), molybdenum (Mo), chromium (Cr), nickel (Ni) and other materials with similar characteristics such as alloys thereof.

Then, as illustrated in FIG. 3B, a photoresist layer 160 is formed on the printing plate 100 on which the metal layer 150 has already been formed. For example, the photoresist layer 160 may include a positive-type photoresist composite, and thus an exposed area of the photoresist layer 160 is removed by a developer and an unexposed area of the photoresist layer 160 remains on the printing plate 100. Alternative exemplary embodiments also include configurations wherein the photoresist layer functions as a negative-type photoresist composite.

A mask 170 having a light shielding portion 172 and a light transmitting portion 174 is then disposed on the printing plate 100 on which the photoresist layer 160 is formed. The light shielding portion 172 includes a first light shielding portion 172a disposed in an area where the first convex portion 110 is to be formed and a second light shielding portion 172b disposed in an area where the second convex portion 140 is to be formed. The light transmitting portion 174 corresponds to areas where the first, second and third concave portions 122, 124, 126 are to be formed. Light is irradiated onto the photoresist layer 160 from an upper side of the mask 170. In the alternative exemplary embodiment wherein the photoresist is a negative-type photoresist, the light and dark areas of the mask 170 would be reversed.

As illustrated in FIG. 3C, the light is irradiated onto the photoresist layer 160 from the upper side of the mask 170, and thus a photo pattern 162 is formed. A photo pattern 162 disposed in an area where the second convex portion 140 is to be formed may have a smaller surface area than a surface area of the second concave portion 124, and an area where the first convex portion is to be formed may have a larger surface area than the surface area of the second convex portion 140 when the photo pattern 162 is formed. For example, the photo pattern 162 disposed in the area where the second convex portion 140 is formed may have a width about twice as large as a depth of the second concave portion 124. In one exemplary embodiment, the photo pattern 162 may have a quadrangular shape.

As illustrated in FIG. 3D, the metal layer 150 is etched using the photo pattern 162 as a mask to form a metal pattern 152. Exemplary embodiments of an etching solution for etching the metal layer 150 may include an inorganic mixed acid solution, an organic acid or other materials with similar characteristics. In one exemplary embodiment, the inorganic mixed acid solution may include nitric acid, acetic acid, phosphoric acid, and other materials with similar characteristics. For example, in an exemplary embodiment wherein molybdenum is used as the metal layer 150, a mixed acid solution mainly including nitric acid, acetic acid and phosphoric acid may be used. In an exemplary embodiment wherein chromium is used as the metal layer 150, a mixed acid solution including hydrochloric acid, nitric acid, etc., may be used.

Then, the printing plate 100 exposed through the metal patterns 152 is isotropically etched using an etching solution, an exemplary embodiment of which is hydrogen fluoride (“HF”). Accordingly, as illustrated in FIG. 3E, the printing plate 100 is isotropically etched in the exposed area, and then the first and second concave portions 122 and 124 are formed. An area in which the first and second concave portions 122 and 124 are not formed are protected from the etching by the overlying metal pattern 152 and the photo pattern 162, and thus they are not removed by the etching such that compared to the first and second concave portions 122 and 124 they are relatively protruded to form the first convex portion 110. The photo pattern 162 and the metal pattern 152 disposed in an area where the second convex portion 140 is formed are stripped via etching the printing plate 100 for forming the second concave portion 124. The second convex portion 140 having a height smaller than the height of a surface of the printing plate 100 is formed in the second concave portion 124. For example, to form the second convex portion 140 in the second concave portion 124, the printing plate 100 is isotropically etched using an etching solution to have a depth of about 10 μm after an area of about 20 μm is protected by a photo pattern. Then, an upper area bordering the photo pattern and the metal pattern is completely etched due to the isotropically etching and undercut phenomenon, so that the photo pattern and the metal pattern are stripped from the printing plate 100. A lower area partially remains after the etching process to form the second convex portion 140. Specifically, while the etching process may not chemically remove the photo pattern 162 and the metal layer 152, the etching solution removes a portion of the printing plate 100 disposed beneath the metal layer 152 and the photo pattern 162 in the region corresponding to the second convex portion 140, thus freeing that portion of the metal layer 152 and the photo pattern 162 to be removed, e.g., by a rinsing process.

Then, the photo pattern 162 and the metal pattern 152 remaining on the first convex portion 110 are sequentially removed. Thus, as illustrated in FIG. 3F, the first convex portion 110, the first concave portion 122, and the second concave portion 124 having the second convex portion 140 inside of the second concave portion 124 are formed. The second convex portion 140 has a second height h2 smaller than a first height h1 of the first convex portion 110.

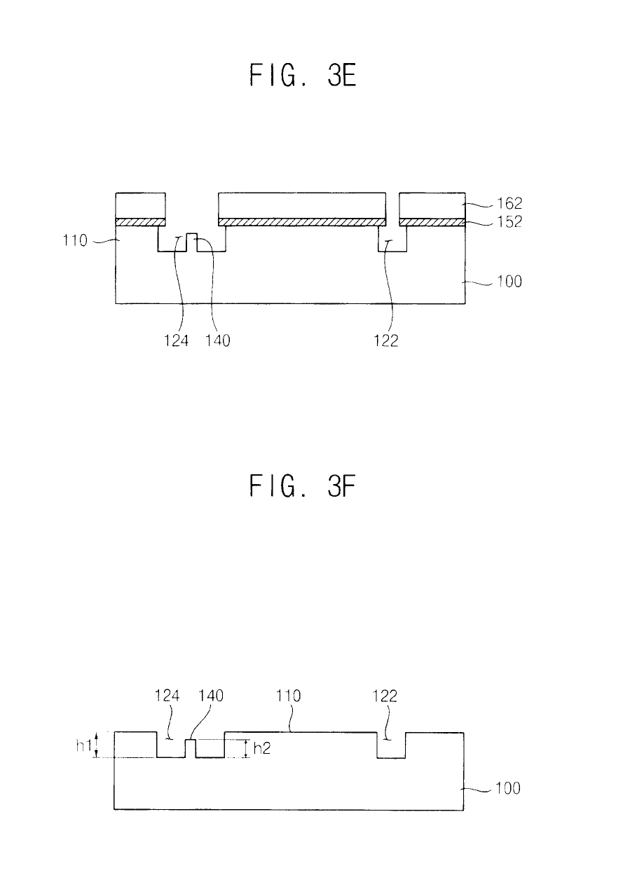

FIGS. 4A to 4D are cross-sectional views explaining an exemplary embodiment of a method of forming an exemplary embodiment of a printing pattern using the printing plate of FIG. 1.

At first, as illustrated in FIG. 4A, the printing plate 100 having a first concave portion 122 and a second concave portion 124 is formed, and then the first and second concave portions 122, 124 are filled with an ink 180. The method of forming the printing plate 100 may be substantially the same as the exemplary embodiment of a method of manufacturing a printing plate described with reference to FIGS. 3A to 3F. Therefore, the same reference numbers are used for the same or similar elements, and any further descriptions concerning the same or similar elements as those shown in FIGS. 3A to 3F will be omitted.

An upper side of the printing plate 100 is coated with the ink 180, and a doctor blade 190 moves in contact with the surface of the printing plate 100 to fill the first and second concave portions 122 and 124 with the ink 180. The first and second concave portions 122 and 124 are filled with the ink 180 by the movement of the doctor blade 190, and the ink 180 remaining on the first convex surface 110 of the printing plate 100 is removed at the same time.

Then, as illustrated in FIG. 4B, a blanket 200 having a roll shape is rolled on the printing plate 100 filled with the ink 180. The ink 180 inside of the first and second concave portions 122 and 124 is transferred to a surface of the blanket 200 which rolls in contact with the surface of the printing plate 100. An ink pattern 182 corresponding to shapes of the first and second concave portions 122 and 124 is formed on the surface of the blanket 200. For example, a groove 182a may be formed on the ink pattern 182 corresponding to the second concave portion 124 due to the second convex portion 140 of the printing plate 100.

Then, as illustrated in FIG. 4C, the blanket 200 on which the ink pattern 182 is formed is rolled in contact with a surface of an object layer 310 formed on a substrate 300. Accordingly, the ink pattern 182 formed on the blanket 200 is transferred to the surface of the object layer 310. When the ink pattern 182 is transferred to the object layer 310 and dried, e.g., via irradiating light to the ink pattern 182 or heating the ink pattern 182, a printing pattern 320 is formed on an entire surface of the object layer 310 as illustrated in FIG. 4D.

A groove 182A formed on the ink pattern 182 corresponding to the second convex portion 140 is small enough so as to not affect the size of the printing pattern 320, and the space occupied by the groove 182 is reformed to be flat during the rolling of the blanket 200 on the object layer 310 and the drying of the ink pattern 182 transferred to the object layer 310. Thus, as illustrated in FIGS. 4C and 4D, a groove corresponding to the second convex portion 140 is not formed on the printing pattern 320 formed on the object layer 310.

Exemplary embodiments include configurations wherein the substrate 300 may be an array substrate or a color filter substrate of a display panel. Exemplary embodiments include configurations wherein the object layer 310 may be a metal layer for forming a gate wiring including a gate line, a gate pad and a gate electrode of the TFT and/or a data wiring including a data line, a data pad and source/drain electrodes of the TFT, or may be a semiconductor layer forming an active layer or various other layers which may require patterning. In addition, the object layer 310 may be an insulating layer, exemplary embodiments of which include silicon oxide (SiOx) or silicon nitride (SiNx). A color filter pattern, a column spacer pattern and various other similar layers may be formed on the color filter substrate using the above described method of forming the printing pattern 320.

According to the present exemplary embodiment, the ink 180 with which the printing plate 100 is filled may be prevented from being removed by the doctor blade 190. Thus, a relatively large-sized printing pattern may be formed without defects caused by the doctor blade 190 undesirably removing portions of the ink from the printing plate 100 during the gravure printing process.

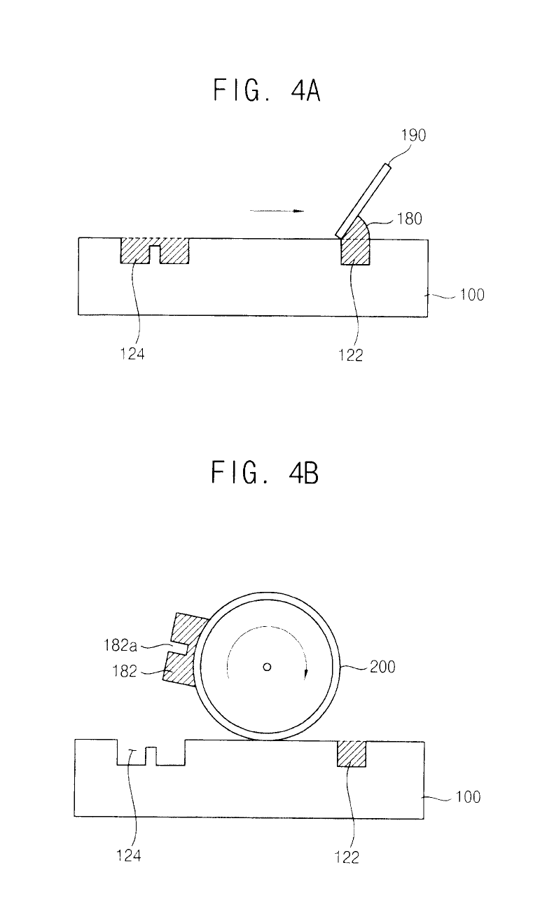

FIG. 5 is a top plan view illustrating another exemplary embodiment of a printing plate for gravure printing according to the present invention.

The present exemplary embodiment of a printing plate 100A for gravure printing may be substantially similar to the printing plate 100 for gravure printing according to the previous exemplary embodiment illustrated in FIGS. 1 and 2 except for a shape of a second convex portion 142. Therefore, the same reference numbers are used for the same or similar elements, and any further descriptions concerning the same or similar elements as those shown in FIGS. 1 and 2 will be omitted.

Referring to FIG. 5, the present exemplary embodiment of a gravure printing plate 100A includes a first convex portion 110, a first concave portion 122, a second concave portion 124 and a third concave portion 126.

The second concave portion 124 includes a second convex portion 142 inside of the second concave portion 124, and the second convex portion 142 has a height smaller than the height of the first convex portion 110, similar to in the previous exemplary embodiment. The second convex portion 142 may have an island shape, also similar to in the previous exemplary embodiment. However, different from the previous exemplary embodiment, the second convex portion 142 may have a circular shape when viewed from a top plan view.

The method of manufacturing the printing plate 100A for gravure printing according to the present example embodiment may be substantially similar to the method of manufacturing the printing plate 100 for gravure printing according to the previous exemplary embodiment illustrated in FIGS. 3A to 3F except for a shape of the second convex portion 142. Therefore, any further descriptions concerning the same or similar elements as those shown in FIGS. 3A to 3F will be omitted. For example, a photo pattern (not illustrated) disposed in an area where the second convex portion 142 is formed has a circular shape. An area of the photo pattern is smaller than that of the second concave portion 124, and larger than that of the second convex portion 142.

In addition, the method of forming the printing pattern using the printing plate 100A for gravure printing according to the present exemplary embodiment may be substantially the same as the method of forming the printing pattern according to the previous exemplary embodiment in FIGS. 4A to 4D. Therefore, any further descriptions concerning the same or similar elements as those shown in FIGS. 4A to 4D will be omitted.

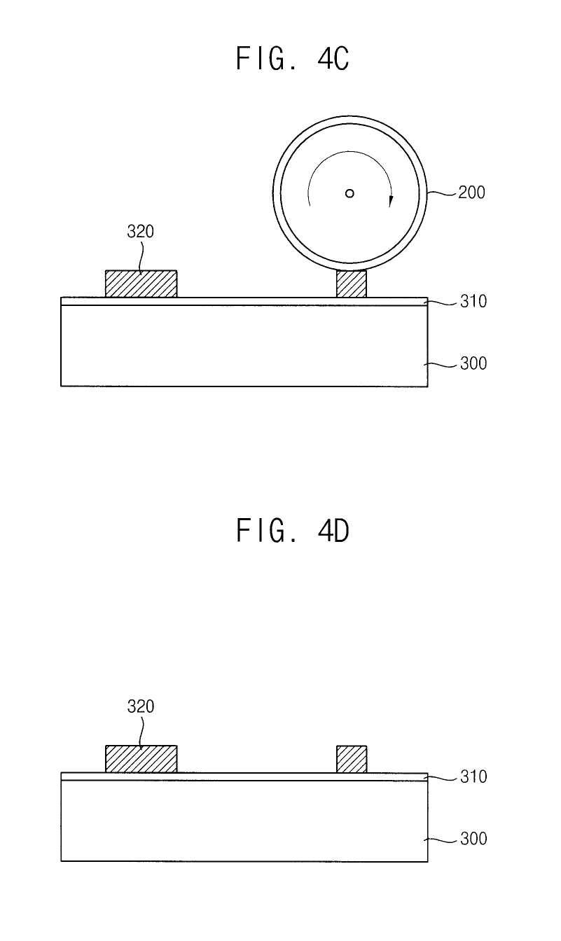

FIG. 6 is a top plan view illustrating another exemplary embodiment of a printing plate for gravure printing according to the present invention.

The present exemplary embodiment of a printing plate 100B for gravure printing may be substantially similar to the printing plate 100 for gravure printing according to the previous exemplary embodiment illustrated in FIGS. 1 and 2 except for a shape of a second convex portion 144. Therefore, the same reference numbers are used for the same or similar elements, and any further descriptions concerning the same or similar elements as those shown in FIGS. 1 and 2 will be omitted.

Referring to FIG. 6, the present exemplary embodiment of a printing plate 100B for gravure printing includes a first convex portion 110, a first concave portion 122, a second concave portion 124 and a third concave portion 126.

The second concave portion 124 includes the second convex portion 144 inside of the second concave portion 124, and the second convex portion 144 has a height smaller than the height of the first convex portion 110, similar to the previously described exemplary embodiments. The second convex portion 144 may have an island shape, also similar to the previously described exemplary embodiments. The second convex portion 144 may have an elliptical shape when viewed from a top plan view.

The method of manufacturing the present exemplary embodiment of a printing plate 100B for gravure printing may be substantially similar to the method of manufacturing the printing plate 100 for gravure printing according to the previous exemplary embodiment illustrated in FIGS. 3A to 3F except for a shape of the second convex portion 144. Therefore, any further descriptions concerning the same or similar elements as those shown in FIGS. 3A to 3F will be omitted. For example, a photo pattern (not illustrated) disposed in an area where the second convex portion 144 is formed has an elliptical shape. An area of the photo pattern is smaller than that of the second concave portion 124, and larger than that of the second convex portion 144.

In addition, the method of forming the printing pattern using the present exemplary embodiment of a printing plate 100B for gravure printing may be substantially the same as the method of forming the printing pattern according to the previous exemplary embodiment illustrated in FIGS. 4A to 4D. Therefore, any further descriptions concerning the same or similar elements as those shown in FIGS. 4A to 4D will be omitted.

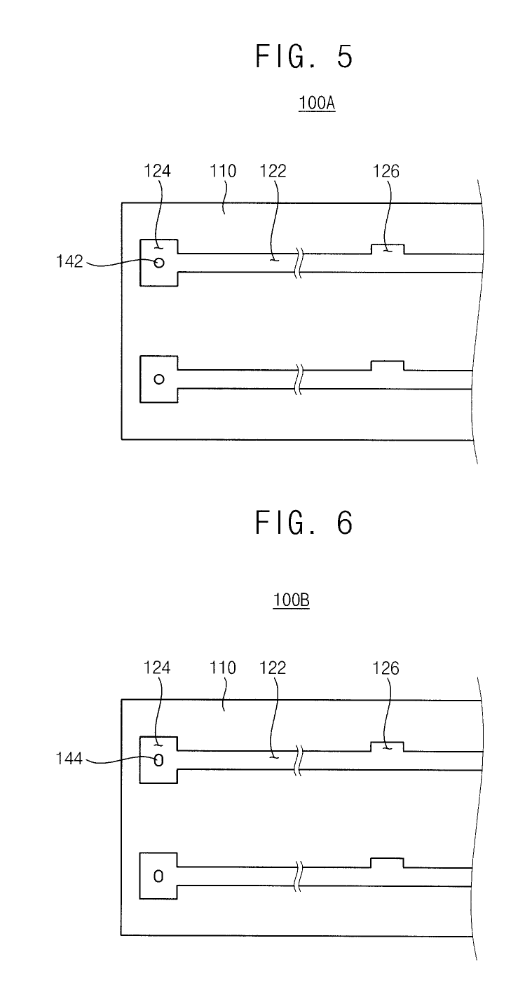

FIG. 7 is a top plan view illustrating another exemplary embodiment of a printing plate for gravure printing according to the present invention.

The present exemplary embodiment of a printing plate 100C for gravure printing may be substantially similar to the printing plate 100 for gravure printing according to the previous exemplary embodiment in FIGS. 1 and 2 except that it includes a plurality of second convex portions 146. Therefore, the same reference numbers are used for the same or similar elements, and any further descriptions concerning the same or similar elements as those shown in FIGS. 1 and 2 will be omitted.

Referring to FIG. 7, the present exemplary embodiment of a printing plate 100C for gravure printing includes a first convex portion 110, a first concave portion 122, a second concave portion 124 and a third concave portion 126.

The second concave portion 124 may include the plurality of second convex portions 146 inside of the second concave portion 124, and the second convex portions 146 have a height smaller than the height of the first convex portion 110. The second convex portions 146 may have an island shape. In one exemplary embodiment, the individual second convex portions of the second convex portion 146 may have a quadrangular shape when viewed from a top plan view. Although not illustrated in FIG. 7, in another exemplary embodiment the individual second convex portions of the second convex portion 146 may have a circle or an elliptical shape when viewed from a top plan view.

The method of manufacturing the present exemplary embodiment of a printing plate 100C for gravure printing may be substantially the same as the method of manufacturing the printing plate 100 for gravure printing according to the previous exemplary embodiment illustrated in FIGS. 3A to 3F except that there is a plurality of second convex portions 146. Therefore, any further descriptions concerning the same or similar elements as those shown in FIGS. 3A to 3F will be omitted. For example, in one exemplary embodiment a photo pattern (not illustrated) disposed in an area where the second convex portion 146 is formed has a quadrangular shape. An area of the photo pattern is smaller than that of the second concave portion 124, and larger than that of the second convex portion 146.

In addition, the method of forming the printing pattern using the present exemplary embodiment of a printing plate 100C for gravure printing may be substantially similar to the method of forming the printing pattern according to the previous exemplary embodiment illustrated in FIGS. 4A to 4D. Therefore, any further descriptions concerning the same or similar elements as those shown in FIGS. 4A to 4D will be omitted.

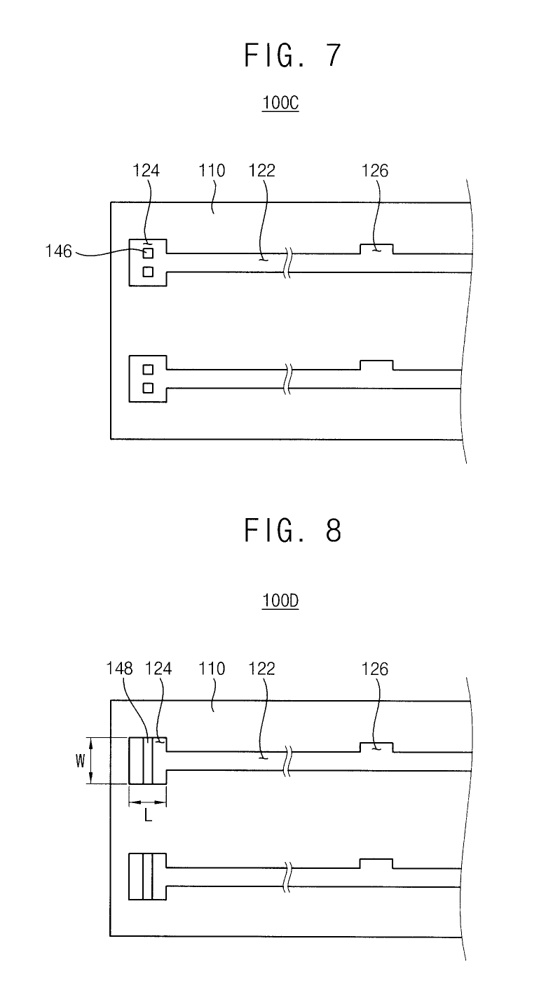

FIG. 8 is a top plan view illustrating another exemplary embodiment of a printing plate for gravure printing according to the present invention.

The present exemplary embodiment of a printing plate 100D for gravure printing may be substantially similar to the printing plate 100 for gravure printing according to the previous exemplary embodiment illustrated in FIGS. 1 and 2 except for a shape of a second convex portion 148. Therefore, the same reference numbers are used for the same or similar elements, and any further descriptions concerning the same or similar elements as those shown in FIGS. 1 and 2 will be omitted.

Referring to FIG. 8, the present exemplary embodiment of a printing plate 100D for gravure printing includes a first convex portion 110, a first concave portion 122, a second concave portion 124 and a third concave portion 126.

In the present exemplary embodiment, the second concave portion 124 may include a second convex portion 148 inside of the second concave portion 124, and the second convex portion 148 has a height smaller than the height of the first convex portion 110. The second convex portion 148 may have a bar shape extending from opposing sides of the second concave portion 124 when viewed from a top plan view.

The method of manufacturing the present exemplary embodiment of a printing plate 100D for gravure printing may be substantially similar to the method of manufacturing the printing plate 100 for gravure printing according to the previous exemplary embodiment illustrated in FIGS. 3A to 3F except for a shape of a second convex portion 148. Therefore, any further descriptions concerning the same or similar elements as those shown in FIGS. 3A to 3F will be omitted. For example, a photo pattern (not illustrated) disposed in an area where the second convex portion 148 is formed has a width equal to the width of the second concave portion 124 and smaller than the length of the second concave portion 124. Thus, as illustrated in FIG. 8, the second convex portion 148 has a bar shape extending toward a width W direction of the second concave portion 124.

In addition, the method of forming the printing pattern using the present exemplary embodiment of a printing plate 100D for gravure printing may be substantially similar to the method of forming the printing pattern according to the previous exemplary embodiment illustrated in FIGS. 4A to 4D. Therefore, any further descriptions concerning the same or similar elements as those shown in FIGS. 4A to 4D will be omitted.

According to the present invention, a convex portion having a height smaller than that the height of a surface of a printing plate is formed for a large-sized printing pattern in manufacturing a printing plate for gravure printing, and thus the convex portion may prevent a doctor blade from partially removing the ink inside of the concave portion of the printing plate. Thus, the large-sized printing pattern having a size larger than about 200 μm may be formed via the gravure printing process without a defect caused by the doctor blade.

The foregoing is illustrative of the present disclosure and is not to be construed as limiting thereof. Although a few example embodiments of the present invention have been described, those skilled in the art will readily appreciate that many modifications are possible in the example embodiments without materially departing from the novel teachings and advantages of the present disclosure. Accordingly, all such modifications are intended to be included within the scope of the present disclosure as defined in the claims. In the claims, means-plus-function clauses are intended to cover the structures described herein as performing the recited function and not only structural equivalents but also equivalent structures. Therefore, it is to be understood that the foregoing is illustrative of the present disclosure and is not to be construed as limited to the specific example embodiments disclosed, and that modifications to the disclosed example embodiments, as well as other example embodiments, are intended to be included within the scope of the appended claims. Embodiments of the present invention are defined by the following claims, with equivalents of the claims to be included therein.

What is claimed is:

1. A printing plate for gravure printing, the printing plate comprising:
a base body;
a first convex portion disposed having a first height on the base body;
a concave portion disposed between adjacent regions of the first convex portion; and
a second convex portion disposed in the concave portion and having a second height smaller than the first height,
wherein the concave portion includes a first concave portion and a second concave portion, and a width of the second concave portion is larger than that of the first concave portion, and the second convex portion is disposed within the second concave portion.

2. The printing plate for gravure printing of claim 1, wherein the base body includes glass.

3. The printing plate for gravure printing of claim 2, wherein the first convex portion and the second convex portion are integrated with the base body into a single, unitary and indivisible body.

4. The printing plate for gravure printing of claim 1, wherein the width of the first concave portion is about 100 μm or more.

5. The printing plate for gravure printing of claim 1, wherein the second convex portion is formed to have an island shape.

6. The printing plate for gravure printing of claim 5, wherein the second convex portion has one of a quadrangular shape, a circular shape and an elliptical shape when viewed from a top plan view.

7. The printing plate for gravure printing of claim 6, further comprising a plurality of second convex portions.

8. The printing plate for gravure printing of claim 1, wherein the second convex portion has a bar shape which extends from both sides of the second concave portion when viewed from a top plan view.

9. A method of manufacturing a printing plate for gravure printing, the method comprising:
disposing a metal layer on a base substrate;
disposing a photo pattern on the base substrate on which the metal layer is disposed;
forming a metal pattern using the photo pattern as a mask; and
etching the base substrate using the metal pattern as a mask to form a first concave portion defined as a space between adjacent first convex portions having a first height as measured from the base substrate and to form a second concave portion having a width larger than that of the first concave portion and including a second convex portion inside of the second concave portion, wherein the second convex portion has a second height smaller than the first height as measured from the base substrate.

10. The method of claim 9, further comprising:
removing the metal pattern and the photo pattern after forming the first concave portion and the second concave portion.

11. The method of claim 9, wherein the photo pattern disposed in an area where the second convex portion is formed has a width about twice as large as a depth of the first concave portion and the second concave portion.

12. The method of claim 11, wherein the photo pattern and the metal pattern disposed in an area where the second convex portion is formed are removed via etching the base substrate to form the first concave portion and the second concave portion.

13. The method of claim 9, wherein the base substrate is isotropically etched.

14. The method of claim 9, wherein the base substrate includes glass.

15. The method of claim 9, wherein the second convex portion is formed to have an island shape.

16. A method of forming a printing pattern, the method comprising:
forming a printing plate including a base body, a first convex portion disposed on the base body with a first height, a concave pattern disposed between adjacent regions of the first convex portion and a second convex portion disposed in the concave pattern and having a second height, wherein the concave pattern includes a first concave portion having a first width and a second concave portion having a second width larger than the first width and the second convex portion is disposed within the second concave portion;
filling the concave pattern on the printing plate with an ink;
rolling a blanket on the printing plate filled with the ink to offset the ink to the blanket; and
transferring the ink to a substrate by rolling the blanket to which the ink is offset on the substrate.

17. The method of claim 16, wherein the second convex portion prevents a doctor blade from entering into the second concave portion when the printing plate is coated with the ink and the ink is moved with the doctor blade to fill the first concave portion and the second concave portion with the ink.

18. The method of claim 16, wherein forming the printing plate comprises:
disposing a metal layer on a base substrate;
disposing a photo pattern on the base substrate on which the metal layer is disposed;
forming a metal pattern using the photo pattern as a mask; and
etching the base substrate using the metal pattern as a mask to form the first concave portion and the second concave portion, the second concave portion having the second convex portion disposed therein.
